(19) United States
(12) Patent Application Publication
(10) Pub. No.: US 2007/0272159 A1
(43) Pub. Date: Nov. 29, 2007

(54) Method and Device for Milking an Animal Provided with at Least One Self-Adjusting Sensor for Monitoring at Least One Milk Characteristic

(76) Inventors: Heinz Francke, Oelde (DE); Friedrich Stolte, Halle (DE)

Correspondence Address: Jeffry W, Smith;Smith Law Office, 440 Science Drive, Ste. 302, Madison,, WI, 53711, US

(21) Appl. No.: 10/576,664

(22) PCT Filed: Oct. 22, 2004
(86) PCT No.: PCT/EP04/11960

§ 371 Date: May 2, 2007

(30) Foreign Application Priority Data
Oct. 24, 2003 (DE) 103 49 577.0

(51) Int. Cl. A01J 5/01

(52) U.S. Cl. 119/14.14

(57) ABSTRACT

The invention relates to a method for advantageously adjusting the values of at least one milk parameter which is detected by a first sensor with the aid of values detected by a second sensor. For this purpose, two separated value systems are advantageously used such that the first sensor is enabled to self-adjust to varying dairy or dairy animal conditions.

The object of the invention refers to a method for providing data for a milk volume or milk amount detection system of a milking installation, a method for adjusting a milk volume or milk amount detection system of a milking installation, as well as to a milk volume or milk amount detection system for a milking installation.

Although below the invention will be described in connection with a milking system for the milking of cows, it is pointed out that the object of the invention is suitable specifically for use in the milking of sheep, goats, llamas, camels, dromedaries, buffalo, mares, donkeys, yaks as well as of other milk-producing animals. The invention can be used both in robot-supported milking installations as well as in fully automatic, semiautomatic, as well as conventional milking installations.

The detection of values of characteristic parameters in milking is known the state of the art in a different form. For example, WO 02/065063 A1 discloses a method for the determination of the amount of milk by using a flow meter based on measurement of electrical conductivity in the milking machine or in the milk line from the milking machine to the milk collecting container. A system is known from EP 0 657 098 A1 in which from measurements of the milk flow in individual animals during milking a possible coming into heat of the animal can be inferred, whereby here too the sensor is built into the milking machine.

Sensors which are integrated in the milking machine or in the milk line of the milking machine to the milk collecting container, although they permit determination of the milk parameters already during the milking process, these sensors require regular calibration in order to ensure accuracy of functioning, which is not only in the intent of the operator but is frequently also required because of legally established limiting values. Especially in relatively large milking installations with a multiple number of milking stations, such a calibration is cumbersome and cost-intensive due to the large number of sensors present. Such a calibration of the sensor must usually be performed at least before the first start-up of a corresponding milking installation.

Based on this, the task of the present invention is to create a method for providing data for a milk amount detection system of a milking installation with the aid of which calibration of the milk amount detection system is simplified.

This task is solved according to the invention by a method for providing data for a milk detection system of a milking installation with the characteristics of claim 1. Advantageous further developments are the objects of the dependent claims.

The method according to the invention for the milking of at least one animal involves the following steps:
A) determination of at least one first value of at least one parameter of the milked milk with a first sensor at least during parts of the milking process;
B) determination of at least one second value of at least one parameter of the milked milk with a second sensor, whereby the second sensor detects values which are averaged over the milk of at least two milking stations and/or at least two animals and/or several milking processes;
C) determination of at least one correction quantity from a function of at least the first and second value which can serve as correction value for subsequent measured value determinations of the first sensor.

Sensors generally always have a specifically systematic measurement error which is produced or altered, for example, depending on the measurement principle of the sensor and/or external influences. The method according to the invention provides the advantage that data can be provided through which a calibration of the first sensor can be achieved in a simple manner. These data can always be newly calculated so that when a limiting value is exceeded, for example, the operator is informed that calibration of at least one sensor is necessary. Instead of the continuous adjustment of correction values, this can also be done discontinuously at predetermined time intervals. The time intervals do not have to be absolutely constant. They can also vary.

The method according to the invention is of special importance in the milk amount detection systems of a milking installation, because the sensors used may come to be soiled or components of the milk may be deposited on the sensor. Cheese formation is a possible contamination. Soiling leads to a drift of the values determined by the sensors and thus to a systematic deviation of the measured results, which must be compensated by a correction value in order to continue to obtain correct measured results. In the sensors known from the state of the art calibration was necessary, while in the method according to the invention a correction of the measured values in the first sensor is done without additional calibration.

Hereby, the system consisting of a first and second sensor has the advantage that two quasi-independent measuring systems are present which are coupled together only very weakly. Thus, a correction of the system of at least one first sensor can be done by correlation with values from the system of at least one second sensor.

If more than one first sensor is used, according to the invention a corresponding number of correction quantities can be determined and used as correction values.

With the aid of the method according to the invention, generation of error messages is also realized in a simple manner. Thus, for example, an error message can be generated when the calibration around a predetermined value changes, for example by 5%. There is also the possibility of checking periodically if the calibration around the predetermined value was exceeded. In addition to a relative value, an absolute threshold value can also be predetermined so that an error message is generated when the absolute value is exceeded.

According to an advantageous embodiment of the method according to the invention, at least one parameter is determined which is taken from a group of parameters, whereby this group comprises the following quantities:

a) amount of milk; or milk volume;

b) inhibitor content of the milk;

c) number of cells of the milk;

d) fat content of the milk;

e) electrical conductivity of the milk;

f) content of components of the milk;

g) pH value of the milk;

h) capacitance of the milk;

i) inductance of the milk;

j) number and/or dimensions of flakes in the milk;

k) color of the milk;

l) optical characteristics of the milk; and

m) acoustical characteristics of the milk.

This listing of the parameters of the group is emmerative, so that other parameters can also be used which can be regarded as suitable.

These quantities always have an influence on the quality and/or quantity of the milk. The amount of milk can be defined via the milk mass and/or the milk volume. When recalculating from milk volume to milk amount, the particular specific density at the particular temperature is to be taken into consideration. Cell number, color and electrical conductivity of the milk are important factors which permit determination if the milked animal has a disease, for example, mastitis.

Under the optical characteristics of the milk, are to be understood properties which can be determined by optical sensors in general, that is, for example, the determination of a transmission of a transmission coefficient or reflection coefficient of the milk, whereby the determination can also be done in a wavelength-specific manner, similarly to a recording of light in the infrared or ultraviolet region.

Acoustical characteristics are properties which can generally be determined with acoustic sensors, for example, the results of ultrasound analysis of the milk. Under components of the milk are specifically included residues from treatment or similar, as well as all other possible substances which are part of the milk, can be dissolved in it and/or suspended in it. The content of flakes and the pH value of the milk are further indices of the quality of the milk, which permit especially information about whether or not the milk has gone sour. Inhibitors are especially antibiotic residues, whose presence in the milk is subject to strict legal regulations.

Especially the measurement of the amount of milk from individual animals is of great importance: not only from the economic point of view, but because the amount of the milk gives information about the performance of the animal, and also from veterinary aspects, since changes in the amount of milk are indication of possible diseases and/or of improper feeding of the animal.

The first sensors are arranged in a milking station in a specific manner, that is, in the milking machine itself or also in the milking line from milking machine to the milk collecting container. The design of milk-machine-specific sensors means that at least as many first sensors are provided as milking machines, or that based on other data, (for example, based on the knowledge as to which milking machine is used at what point in time), the data of a first sensor which is connected with several milking machines enables one to refer back to the milking machine from which the milk just detected originates.

These sensors can be designed, for example, as flow meters, which measure the particular liquid flow through the milking machine and/or milk line. The first sensors provide values which correspond ideally to the volume of milk flowing through. However, it is known that each sensor has a sensor-specific measurement error which must be eliminated by adjustment, for example by calibration, in order to obtain reliable measured values. Another systematic error can arise, for example, during continuous and/or repeated use of the first sensor, for example by soiling or especially by cheese deposition. Such contamination or cheese depositions lead to a permanent deviation of the obtained measured values in one direction, whereby the size of the deviation usually increases with time. Now, if the measured values of the individual first sensors are compared with a value determined by the second sensor, which is averaged over several milking machines and/or several animals and/or several milking processes, the values of the first sensor can be corrected correspondingly.

Since the correction quantity is determined with the aid of a function of at least the first and second values of at least one parameter, in the case of several first sensors, a correction is done with the aid of the values of all first sensors and of the second sensor. As function, one can choose, for example, a simple difference function, but one can also use, for example, a general correlation function.

On the example of milk amount measurement, this would mean that an amount of milk in a milk collecting container is determined on the one hand with the aid of the signals yielded by the first sensor, in which in case of flow meters the values are also integrated over time, and thus the amount of milk milked with the individual milking machines is measured, and, on the other hand, it is determined by a second sensor which determines the volume of milk stored in the milk collecting container. A possibility of determining the correction quantity consists, for example, in forming the difference of these two values, dividing them by the number of first sensors and using this quantity as correction quantity. However, it is also possible to take into consideration statistical probabilities, influences specific to individual animals, influences specific to the individual milking stations, special statistical weighting or similar in the determination of the correction quantity.

Instead of having the second sensor in a milk collecting container, it can be located, for example, behind a point at which the milk lines of several milking stations are combined, at which point milk milked by several milking machines flows or is present. For example, at least one second sensor can also be incorporated in a tanker in which the milk is transported. This leads directly to an averaging of the milk milked with several milking machines. Averaging over the milk of several animals is done, for example, when at each milking station, that is, with each milking machine, always the same animals are milked or using the same milking machine, that is, at the same milking station, several animals are milked, which is usually the case. Averaging over several milking processes can be done, for example, by determining the value of at least one second sensor when several milking times, that is, several intervals elapsed in which, for example, all animals of a herd were milked once before determining the value of the second sensor.

According to another advantageous embodiment of the method, the second sensor detects values of the parameters in a milk collecting container and/or in a tanker.

Since the collection of the milked milk in a tanker is a regularly-performed process, the design of the second sensor in such a container is advantageous because here measured values which are averaged over several milking machines and/or several animals and/or several milking processes in the sense of the invention can be detected in a simple manner.

The present determination of the correction quantity can be integrated advantageously in already-existing semiautomatic or fully automatic milking installations. Here frequently milk-machine-specific sensors already exist which can be provided with a correction value according to the method of the invention. Especially milking processes that are at least partially automatic have well-defined initial conditions during milking which yield fundamentally reproducible measurement results which can be corrected advantageously according to the invention using correction values.

According to another advantageous embodiment of the method according to the invention, in step C) an equipartition of the deviation of the second value from the corresponding first values can be performed.

On the example of measurement of the amount of milk, this means that first values of the amount of milk are always the values of the first sensor, for example of a flow meter, which are determined in a number of milking machines in a milking-machine-specific manner, and a second value is taken from the average value of the milk milked by these milking machines. The deviation determined from these values is then assumed to be caused to the same degree by all milking machines and the correction quantity is determined correspondingly.

According to another advantageous embodiment, in step C) animal-specific influences and/or milking-machine-specific influences and/or milking-station-specific influences are taken into consideration, whereby each milking machine is assigned to a milking station.

In this advantageous further development, for example it can be taken into consideration as to which animal is milked when, and which values of the first sensor are related to the milking process of this animal. For example, if the amount of milk is determined as milk parameter, then, in the determination of the correction quantity, the amount of milk expected from this animal can be taken into consideration. As another example, one can use the average milk flow amounts expected for a milking station or a milking machine, and it can be taken, for example, into consideration if in several successive milking processes the flow amount varies statistically around this value or if the values detected by the first sensor are always systematically above or below this value. In addition to the amount of flow, the same also applies to the amount of milk milked per milking station and milking process, and here too animal-specific expected values can be taken into consideration.

According to another advantageous embodiment of the method according to the invention, at least one first value of at least one parameter of the milk in the milking machine and/or in the milk line from milking machine to milk collecting container is determined.

Both the design of the first sensor in the milking machine as well as in the milk line from milking machine to milk collecting container allow for simple, advantageous detection of the milking-machine-specific values of the parameter.

According to another advantageous embodiment of the method according to the invention, based on the correction quantity and/or correction value, one can draw conclusions regarding leakages in the milking machine and/or in a milk line and/or in the milk collecting container, whereby the parameter comprises at least the amount of milk milked.

The determination of the amount of milk as milk parameter permits in the method according to the invention, in a simple manner, the detection of small or large leaks. For example, when the amount of milk detected by the first sensors at a given milk station or at a given milking machine is too low over several milking processes, and especially to a considerable extent, then this indicates a leak between the milking machine and the milk collecting container. If the value of the amount of milk determined based on the values of the first sensor the amount of milk measured is higher, especially considerably higher, over several milking processes or milking times, then the value detected by the second sensor for example in the milk collecting container, then this indicates a leak in the milk collecting container. When investigating leaks, statistical data especially of the milked animals can be used advantageously to exclude or reduce other influences on the values of at least one first or at least one second sensor.

According to another advantageous embodiment of the method according to the invention, the second sensor detects the amount of milk milked at least optically, acoustically and/or mechanically, whereby the parameter comprises at least the amount of milk milked.

The determination of the amount of milk especially in the milk collecting container can be done optically, especially by transmission and/or reflection. Furthermore, the second sensor can detect the amount of milk present in the milk collecting container acoustically, especially based on ultrasound, or mechanically, for example in the form of a float.

The method according to the invention is especially suitable in cooperation with a process control or herd management system, since both the process control or the herd management system detects the amount of milk of the individual stations and of one or more milking times of all the milk amount measuring equipment and compares it with the amount in the milk tank. In the ideal case, that is, in the case of an absolutely exact measurement, the sum of the amounts of milk of all milking stations corresponds to the amount of milk of one milking time. Due to different influencing factors, the quantities determined at the individual stations by the milk amount measuring equipment is inaccurate so that the sum usually does not correspond to the total amount of milk of the milking time. This deviation is reduced by the method according to the invention. For example, in the present invention, a herd management program or a central or decentralized data processing device determines the deviation of the amounts of milk measured from the centrally detected amount in the milk tank. The error between the amount of milk measured centrally and the sum of the individual measurements of the milk amounts at the particular milking stations is calculated. As a result, a correction quantity is provided to all milk amount measuring equipment at the milking stations which serves for adjusting the sensor. This adjustment is done preferably automatically. Hereby, for example, the individual sensors can be controlled correspondingly by the process control or by the herd management system.

Say, for example, the total amount of milk of the milk milked at the individual stations is 100 liters, while 102 liters are obtained from the measurement of the amount of milk of the tank. Thus, a total of 2% more milk arrived into the tank than follows from the sum registered by the individual pieces of equipment that measure the amount of milk. In this simple case, a correction value can now be sent for calibration to all milk sensors, whereby this correction value is 2% higher than the previous one. In case of uniform distribution of the error and same amounts of milk measured at the individual milking stations, this will lead to a correct adjustment of the sensor.

Preferably a qualitatively better sensor is used for the second sensor, which has a higher classification or higher accuracy. The first measuring sensor can be better volume oriented and the second can be amount or mass oriented or volume oriented or vice versa.

In a more complex embodiment, each individual milking station or each individual milk sensor is calibrated individually, in that influences specific to the milking station or to the animal are drawn upon. Especially, the herd management can calculate the amount of milk expected for each cow. By comparing the expected amount of milk and the actually-measured amount of milk, a new correction value can be derived which will lead to more accurate results. For example, if 300 animals are milked in a herd at 30 milking stations, then at each station an average of 10 different animals are milked. Based on an analysis as to whether individual milking stations detect on the average less or more than the expected amount of milk, an individual adjustment of the individual milking stations can be performed. As a result of the invention, extensive manual calibration by individual persons can be eliminated at least partially.

In the method according to the invention, the data of the tanker or of the milking time can be used as sensor data of a second sensor so that no second sensor has to be present in the installation. The control amount can also be provided through an installation-dependent sensor. The control value can be entered manually or transferred in a wireless manner, for example by radio, Bluetooth, WLAN, SMS, e-mail and through the Internet and other means.

The method according to the invention also opens up the possibility of using information from a herd management system. The herd management system contains data on individual animals, for example data on the health of the animals, veterinary treatments, mating, etc. By linking the method according to the invention with data of the herd management system, certain abnormal conditions or conditions which go beyond a predetermined threshold value can be recognized and taken into consideration in the determination of the relevant data. Thus, for example, the linking of the method with the data of the present health of the animals creates the possibility of identifying mavericks and optionally to eliminate them. It is also possible to generate flexible communications.

If at least one parameter is determined based on optical properties of the milk, then it is advantageous when this is done with the aid of filters, especially with the aid of at least on cut-off filter. With a cut-off filter the light is absorbed essentially completely up to a given wavelength. By using a texture filter, the surface structure of the object can be determined and can be stored optionally for further processing.

Even valuable gauges can be used in the realization of the method according to the invention, since the method according to the invention leads to an improvement of the accuracy.

The present invention furthermore is based on the goal of providing a milking detection system for the amount of milk for a milking installation which yields more reliable values, for example regarding the milked amount of milk, especially, for example, of the flow amount.

This goal is achieved by a milk detection system for a milking installation with the characteristics of claim 10. Advantageous further developments and embodiments of the detection system for the amount of milk are the object of the dependent claims.

The milk amount detection system according to the invention for a milking installation has at least one first sensor which detects at least one first value for at least one parameter at the milking station. With the aid of at least one second sensor, which is assigned to a milk collecting container, at least one second value is determined of at least one parameter of the milk in the milk collecting container. A control unit is connected to the sensors, which reads the values detected by the sensors, stores them and/or processes them. The control unit determines at least from at least one first parameter and from at least one second parameter of the characteristic value at least one characteristic value and utilizes this characteristic value as a correction value in order to correct the future measured value of at least one first sensor.

With a device according to the invention the method according to the invention can be realized in an especially advantageous manner.

According to a further advantageous embodiment of the device according to the invention, the control unit has storage for storing at least information specific to the animals, milking machines and/or milking parlors.

Thus this information can be entered, especially with the determination of at least one correction quantity.

According to another advantageous embodiment of the device according to the invention, the sensors can detect at least one of the following quantities:

a) amount of milk; or milk volume;

b) inhibitor content of the milk;

c) number of cells of the milk;

d) fat content of the milk;

e) electrical conductivity of the milk;

f) fraction of components of the milk;

g) pH value of the milk;

h) capacitance of the milk;

i) inductance of the milk;

j) number and/or dimensions of flakes in the milk;

k) color of the milk;

l) optical characteristics of the milk; and

m) acoustical characteristics of the milk.

The mentioned advantages and details for the method according to the invention can be used in the same way for the device according to the invention and vice versa.

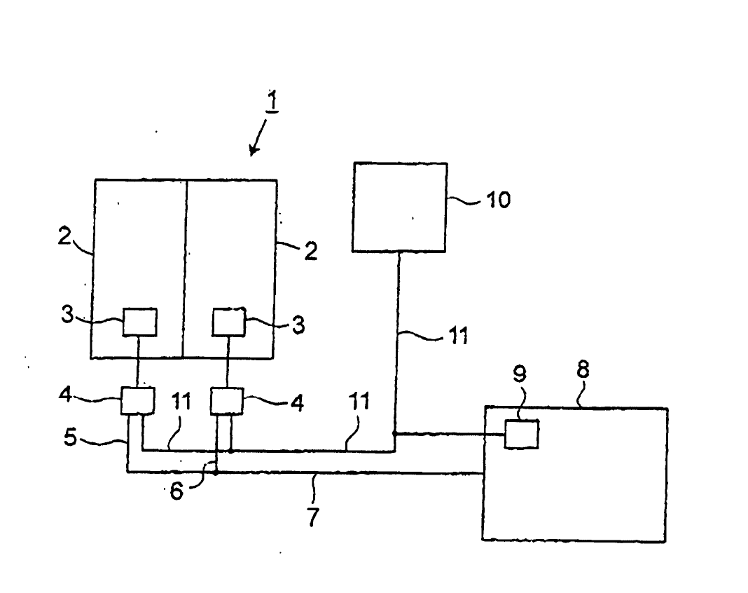

Below further details of the invention and a preferred practical example will be explained with the aid of the drawing, the single FIG. 1, which shows schematically a device according to the invention without the invention being limited to it.

FIG. 1 shows a milking installation 1 which has two milking stations 2, whereby an arbitrary different arrangement of milking stations 2 and/or an arbitrary other number of milking stations 2 are possible. Each of the milking stations 2 is equipped with a milking machine 3, which is adapted in its design to the type of animal to be milked. Thus, for example, a milking machine 3 would have four teat cups for cows, the dimensions of which are adjusted to the teats of cows. Similar milking machines 3 are also possible according to the invention for the milking of sheep, goats, buffalo, horses, etc.

A sensor 4 is assigned to each milking machine 3 and this can detect first value K1 of at least one parameter K of the milk. These first sensors 4 are each installed in a first milk line 5 and a second milk line 6, which pass the milk from milking machines 3 to a milk collecting line 7, through which the milked milk in all milking machines 3 flows into a milk collecting container 8. Since the first sensors 4 are always placed in parts of the milk line 5, 6 which are milking-machine specific, that is, through which the milk flowing was milked only in a given milking machine 3, with the aid of these sensors 4, first values K1 of the parameter K can be detected which are specific for the milk that was milked in this milking machine 3.

In milk collecting container 8 a second sensor 9 is located which can detect second values K2 of parameter K. Since in the milk collecting container 8 the milk from various milking machines 3 is collected and mixed, the second sensor 9 yields second values K2 of parameter K which are averaged at least through the milk of different milking machines 3. Since ordinarily different animals are milked at each milking station 2, usually also information about the milk of different animals and also of different milking processes is obtained. Especially an averaging over different milking times can be performed, whereby a milking time is defined as a time span within which all animals of a herd are milked once.

Furthermore, the milking installation 1 has a control unit 10 which is connected through a data bus system 11 to sensors 4, 9. The data bus system 11 represents a special form of connection of the individual elements through control lines, which is addressable and easily expandable. The data are transferred through the data bus system 11 at least from sensors 4, 9 to control unit 10 and vice versa.

In the following, as an example, the case will be considered in which the parameter K is the amount of milk. The amount of milk can be determined, for example, with flow meters which measure, for example, the volume flow per unit time. Integration over time yields the amount of milk milked. Such flow meters can be based on various physical principles.

When such flow meters are used as first sensor 4, then the volume of milk milked per milking machine 3 and milking process can be measured and transferred to the control unit 10 via the data bus system 11. In corresponding, not shown, memory means, at least these values can be stored. Optionally, integration over time can be performed in control unit 10. Thus, in case of different milking stations 2, the milk volumes MI milked at the individual milking stations 2 are present in control unit 10. A summation of these milk volumes MI in control unit 10 yields the total volume of milk MG1, milked and determined with the first milk sensor 4:

$$MG 1 = {\sum }_{l} MI$$

At the same time a second value K2 determined by a second sensor 9 represents the total milked milk volume MG2. The second sensor 9 can detect the milked milk volumes for example optically, acoustically and/or mechanically. In the ideal case we should have
MG1=MG2
but there are always deviations here, which are based especially on measurement errors of the values K1 and K2. Thus the following applies

$$MG 2 = MG 1 + Δ MG = {\sum }_{l} MGI + Δ MG$$

The deviation ΔMG is calculated as the difference of the two detected milked milk volumes MG1, MG2. In order to eliminate this deviation or to reduce it, at the detection of the first values K1 a corresponding number of correction values KW can be taken into consideration. An individual correction value KWI can be assigned to each milk volume MI detected by a first sensor 4. A simple way of calculating these correction values KWI consists in assuming an equipartition of the measurement errors of the first sensor 4, that is, assuming that each of the first sensors 4 has a measuring error of equal magnitude. In this case, in system control 10, a correction quantity KG is calculated by dividing the deviation ΔMG by a number N of the detected milk volumes MI:

$$KG = \frac{Δ MG}{N}$$

The correction value KG thus determined in control unit 10 is then taken as correction value KWI. Since in case of equipartition all individual correction values KWI are identical, a general correction value KW which corresponds to the individual correction values KWI can be used for correction of later determined measured values detected by sensor 4.

Preferably for the second sensor a sensor is used which has a higher accuracy than the first sensor. A system of several sensors can also be used as second sensor, which sensors are based on different physical principles. The individual sensors of the second sensor are then, for example, averaged.

However, it is equally possible to perform a different weighting of the errors of the individual first sensors 4. For example, a number of individual correction quantities KGI can be taken into consideration for the individual first sensors 4, the number of which preferably corresponds to the number of first sensors, using corresponding weighting factors. These weighting factors can be based on any arbitrary statistical distribution. Especially here information can also be introduced which is specific to the milking parlor, milking machine and/or animal. For example, it can be considered here that a certain first sensor 4 has relatively large deviations because of increasing soiling or that a certain animal for example has problems during the milking process which regularly leads to deviations in the milk volume, or that the condition of the animal leads to milk amounts different than usual. In addition, one can take into consideration the time sequence of the milking of the milk volumes MI in which, for example, milk volumes MI which are older will receive a smaller weight than the milk volumes MI which are more recent. The correction quantities KGI are then determined, for example, with the aid of multi-dimensional regression.

After the individual correction quantities KGI or a general correction quantity KG have been determined, these are used for the subsequent measured value determinations of at least a first sensor 4 as correction value KW. This means that a measured value K1 which is determined by a first sensor 4 is considered to be K1+KW. Hereby it should be pointed out that the correction value KW can assume both positive as well as negative values and that the individual correction values KWI can be used for each first sensor 4.

The procedure described here for the determination of milk volume can also be employed for any arbitrary other parameter of the milk or even for several parameters of the milk, advantageously, according to the invention.

The method according to the invention makes it possible to correct in an advantageous way the values K1 of at least one parameter K of the milk which are detected by at least one first sensor 4, with the aid of at least the values K2 which are detected by a second sensor 9. Hereby, advantageously, two separate systems of K1, K2 values are used for correction. This makes it possible to provide reliable self-adjustment of the first sensor 4 in an advantageous manner.

### REFERENCE LIST

1 Milking installation
2 Milking station
3 Milking machine
4 First sensor
5 First milk line
6 Second milk line
7 Milk collecting line
8 Milk collecting container
9 Second sensor
10 Control unit
11 Data bus system
K Parameter
K1 First value of the parameter
K2 Second value of the parameter
KG Correction quantity
KGI Individual correction quantity
KW Correction value
KWI Individual correction value
MG1 Total milked milk volume calculated from measured values of at least one first sensor
MG2 Total milk milked volume determined by at least one second sensor
MI Individual milk volume detected by first sensors
N Number of measured values

1. A method for providing data for a milk amount detection system of a milking installation, comprising the following steps:
A) determining a first value of a parameter of the milk with a first sensor;
B) determining a second value of a parameter of the milk with a second sensor; and
C) determining a correction quantity from a function of at the first value and the second value to serve as correction value for subsequently measured value determinations of the first sensor.

2. The method according to claim 1, in which the parameter is selected from a group of parameters consisting of:
a milk amount, an inhibitor content, a cell number, a fat content, an electrical conductivity value, a fraction of components, a pH value of the milk, a capacitance, an inductance, a number of flakes, dimensions of flakes, a color, an optical characteristic, and an acoustical characteristic of the milk.

3. The method according to claim 1, and further comprising the step of:
collecting milk in a milk collecting chamber, in which the step of determining a second value of a parameter with a second sensor is performed.

4. The method according to claim 1, and further comprising the step of:
assigning the first sensor a correction value.

5. The method according to claim 1, and further comprising the step of:
considering individual animal data when determining a correction quantity.

6. The method according to claim 1, wherein the step of determining the first value of at least one parameter of the milk takes place at a milking machine.

7. The method according to claim 1, in which the parameter comprises the amount of milked milk.

8. The method according to claim 1, in which the parameter comprises an amount of milk milked, and the second sensor detects an amount of milked milk optically.

9. The method according to claim 1, and further comprises the step of automatically adjusting the first sensor with the correction quantity.

10. A milk amount detection system for a milking installation, comprising:
a first sensor which detects a first value of a parameter at the milking station;
a second sensor which detects a second value of a parameter of milk in a milk collection container; and
a control unit in communication with the first and second sensors, wherein the control unit reads the first and second values detected by the first and second sensors, determines a correction quantity from the first value and the second value of the parameter, and uses this correction quantity as the correction value to correct future measured values of the first sensor.

11. The milk amount detection system according to claim 10, wherein the control unit has a memory for storing animal-specific information.

12. The milk amount detection system according to claim 10, wherein the first and second sensors determine properties taken from a group of parameters consisting of:
a milk amount, an inhibitor content, a cell number, a fat content, an electrical conductivity value, a fraction of components, a pH value of the milk, a capacitance, an inductance, a number of flakes, a dimension of flakes, a color, an optical characteristic, and an acoustical characteristic of the milk.

13. The device according to claim 10, wherein the first sensor is disposed between a milking machine and a milk collecting container.

14. The method of claim 1, wherein the step of determining a second value of a parameter comprises the step of:
determining a characteristic for the milk from a plurality of animals.

15. The method of claim 1, wherein the step of determining a second value of a parameter comprises the step of:
determining a characteristic for the milk from a plurality of milking processes.

16. The method of claim 1, wherein the step of determining a second value of a parameter comprises the step of:
determining a characteristic for the milk from a plurality of milking stations.

17. The method of claim 1, wherein the step of determining a correction value comprises the step of:
considering milk-station-specific influences on the first and second values.

18. The method according to claim 1, wherein the step of determining a correction value comprises the step of:
correcting for leaks in the milking installation.

19. The method according to claim 1, in which the parameter comprises the amount of milk milked, and the second sensor detects the amount of milk milked acoustically.

20. The method according to claim 1, in which the parameter comprises the amount of milk milked, and the second sensor detects the amount of milk milked mechanically.

21. The milk amount detection system according to claim 10, wherein the control unit has a memory for storing milking machine-specific information.

22. The milk amount detection system according to claim 10, wherein the control unit has a memory for storing milking parlor-specific information.
